(19) United States
(12) Patent Application Publication
(10) Pub. No.: US 2025/0228245 A1
(43) Pub. Date: Jul. 17, 2025

(54) COMPOSITIONS AND METHODS FOR TREATING FLATWORMS

(71) Applicant: New Guinea Flatworm Spray, Inc., Port St. Lucie, FL (US)

(72) Inventors: Jeannine Tilford, Port St. Lucie, FL (US); Brian Hicks, Hobe Sound, FL (US)

(21) Appl. No.: 18/413,456

(22) Filed: Jan. 16, 2024

(51) Int. Cl. A01N 59/06; A01N 25/30; A01N 27/00; A01N 31/02; A01N 37/04; A01P 15/00

(52) U.S. Cl. CPC A01N 59/06; A01N 25/30; A01N 27/00; A01N 31/02; A01N 37/04; A01P 15/00

(57) ABSTRACT

Compositions, and methods, for selectively controlling and killing invasive flatworms in Phylum Platyhelminthes. The compositions and methods are designed to control invasive flatworms, their eggs, their cocoons, and their reproductive fragments in and on plants, plant tissue, plant transportative material, water, soil, turf, roots, root balls, sidewalks, drive ways, play areas, common areas, and surfaces and substrates that are both permeable and impermeable. The composition comprises: 1) degreasing solvent, 2) a surfactant compound, 3) an acid or base, and 4) a monohydric alcohol.

### FIELD OF THE INVENTION

The present invention relates to compositions, and methods, to control pest infestations; and more particularly, to chemical compositions, and method of use thereof, for killing or inhibiting the spread of flatworms in Phylum Platyhelminthes.

### BACKGROUND OF THE INVENTION

Recent history is replete with examples of foreign, non-native plants and animals invading native ecosystems and either severely disrupting them or destroying them. With the advent of global transportation and commerce, a growing number of plant and animal species have been either accidently or deliberately introduced into foreign environments with often devastating results.

Although it is generally believed that the American chestnut blight originated at the Bronx Zoo in New York City during the summer of 1904 (Merkel, Hermann W. (1905). A Deadly Fungus on the American Chestnut, N. Y. Zoological Society, 10^{th} Annual Report, pp. 97-103), it likely entered the United States much earlier. The blight, caused by ascomycete Cryphonectria parasitica, quickly spread across the eastern third of the United States. Within thirty-five years, approximately four billion American chestnut trees had been lost (Roane, Martha K., Griffin, Gary J., Elkins, J. R. (1986). Chestnut Blight, Other Endothia Diseases, and the Genus Endothia. APS monograph series. APS Press, American Phytopathological Society. pp. vii53). The resultant loss of almost one of every four trees in the forests of Appalachia disrupted ecosystems, industries, and staples of American livelihood. And, while the loss of an extremely high-grade wood source along with disrupted local economies and agriculture, it was the loss of den trees, nut production, and a variety of wildlife habitats which produced dramatic ecological consequences (Freinkel, Susan (2007) American Chestnut: The Life, Death, and Rebirth of a Perfect Tree, University of California Press p 294). Even passenger pigeons, already in severe decline by the late 1800's due to over harvest, were known to rely on American chestnuts for forage and roosting sites.

Invasive plant species like kudzu, Pureraria lobata, Brazilian pepper, Schinus terebinthifolia, and Tree of Heaven, Ailanthus altissima are just a few of the exotic plants that are currently expanding their ranges at the expense of native plant and animal communities (Dawkins, K., Esiobu, N. (2016 May 24) “Emerging Insights on Brazilian Pepper Tree (Schinus terebinthifolius) Invasion: The Potential Role of Microorganisms” Frontiers in Plant Science 7:712). The United States Department of Agriculture estimates that there are 5,000 non-native plant species actively growing in the United States. Although not all these plants are harmful or currently destructive to an ecosystem, their presence alone forebodes potential expansion into vital habitat and shared space. Shifts in an ecosystem either caused by their presence or stimulated by alternative causes such as global warming can trigger unwanted expansion and competition with native species. Stress placed on an ecosystem due to non-native plant expansion and competition is extremely difficult to calculate. When sub-acute, chronic stress occurs in an ecosystem, the native organisms may not perish outright but will often be more susceptible to the combined effects of the conditions generated by the invasive species. There will often be an increase in malnutrition, increased disease susceptibility, and a reduction in the availability of mating partners. Potential effects on animal communities that rely on native plant species for food, concealment, habitat utilization or on their prey species food, concealment, and habitat utilization may easily deteriorate as a non-native species expand and broaden their range. Each introduction and subsequent expansion of invasive plants into an ecosystem causes a cascade of unwanted negative interactions that can disrupt food chains, reproduction habitat, and competition between animal communities.

Of the animal phyla, flatworms are some of the least understood and most widespread invasive threats worldwide. This is because many flatworm species are nocturnal. They live in damp, unobtrusive environments often concealed by soil and vegetative matter, and are easily overlooked. They can reproduce and spread unnoticed for years. Their presence often goes unrecognized until major problems are occurring. This would include problems such as diminished harvests, vanishing native species, and increases in illness and mortality among animal and human hosts.

The most recent introductions of invasive flatworms across international borders have typically been contained in ornamental and agricultural plant materials, e.g., the root balls of imported plants, or the seeds or fruits of plants that are to be grown for crops (Justine, Jean-Lou, Winsor, Leigh (2020 Feb. 6) “Obama nugara: how a flatworm from Argentina jumped the Atlantic and invaded France”. The Conversation). In the past, little concern was given to the possibility of unwanted hitchhikers in those materials. Unfortunately, most introductions occur in new environments long before the detection of foreign invasive flatworms has been recognized. In many, if not most cases, the flatworms spread into the natural ecosystems of the countries that imported them without interdiction. Often, many years will pass before the invasive flatworms are detected. At which point, the worms will have already begun to inflict significant harm in their new habitats while significantly expanding their presence far from the initial point of origin.

The Hammerhead flatworm, Bipalium kewense, was first detected in Kew Gardens in London in the late 1800's (Katz, Brigit (2018 May 25) Hammer Flatworms Have Been Quietly Invading France for Two Decades, Smithsonian Magazine). These, along with other non-native flatworms, are believed to have originated primarily from Australia and New Zealand, and have now spread and taken up permanent residence throughout Europe and in the United States. They are currently especially prevalent in France (Justine, J-L, Winsor, L., Delphine, G., Gros, P., Thevenot, J. (March 2014) The Invasive New Guinea flatworm Platydemus manokwari in France, the record for Europe: time for action is now. Peer J—Plant Biology Section, PubMed 24688873). Hammerhead flatworms large (up to one meter in length) and hearty. The faster invasive flatworms are invariably able to run down native earthworms, a primary food source, and consume them before they can escape. Moreover, they are extremely voracious predators and have been known to decimate local earthworm and other indigenous worm populations in very short order (Guarino, Ben (2018 May 22) Giant predatory worms invaded France, but scientists just noticed them. Washington Post). This can be especially problematic for ongoing agricultural interests since earthworms are needed to both aerate soils with their tunnels and to fertilize soils with their fecal castings.

In many types of agriculture, soil aeration, rainwater penetration, and earthworm castings (feces) are essential for critical nutrient recycling and easier plant nutrient absorption. This is particularly important in vineyards throughout France where the loss of native worms have negatively affected the productivity of the soil. The wholesale destruction of earthworm communities by flatworms, as being experienced in France and other industrialized countries, has become a cause of great concern. In the coming years, French vineyards may be subjected to reduced yields due to decreasing numbers of native earthworms.

In Scotland and Ireland, research has demonstrated that yields of agricultural grasses have been reduced by six percent due to the expanding populations of invasive flatworms. This means potential multi-billions of dollars' worth of crop agriculture is at risk if these non-native flatworm predators continue to expand and spread their range. The flatworm species Artioposthia triangulate and Geoplana sanguinea, believed to be accidently imported into England and France in the 1950s and 1960s, probably came contained in the root balls of ornamental plants. There are justified, documented concerns that populations of these species are also expanding and have been reported to be capable of eradicating entire earthworm populations on farms, agricultural combines, and in ornamental plant production facilities. Beneficial indigenous earthworms, like innumerable native snails, slugs and nematodes have no natural defense against predatory invasive flatworms. (Sluys, Ronald (September-October 2016) “Invasion of the Flatworms” American Scientist Vol. 104, Number 5 Pg 288).

In the United States, and especially along the East Coast of the United States, the spread of invasive flatworms has become alarming (Ambrose, Kevin, Patel, Kasha (2023 Jul. 22) Toxin-secreting hammerhead worms are invading the D.C. area. How to stop them). As in other areas, hammerhead flatworms are causing serious disruption in native fauna populations. Hammerhead flatworms, like other flatworm species manufacture and excrete toxic compounds in their slime and throughout their bodies. Among the toxins contained in those compounds are tetrodotoxins, which in many cases are identical to the neuro toxic compounds found in puffer fish. While the level of toxin in one flatworm is unlikely to cause death in a human, a pet or other animal that accidently or intentionally ingests multiple flatworms could potentially suffer fatal consequences.

Examples of pet deaths, particularly canines, caused by interaction with the invasive amphibians throughout the southern United States have become all too familiar. Estimates of pet mortality caused by “Bufo or cane toads” typically run into the hundreds throughout Florida each year. Now, with increasing regularity, local news media outlets throughout the eastern United States are beginning to recognize and warn citizens of the increase of non-native flatworms and the potential hazards they pose to humans and pets (Shipley, Kaylee (Aug. 17, 2023) Hammerhead worms surface in East Coast: Why they pose danger to you and your pets” WSET staff; Fox 5 Washington, D.C. (July 2023) Hammerhead worms becoming a problem in the DMV youtube.com/watch?v=WKYqYh8yuk).

Of these, a relatively new invasive flatworm species is now spreading throughout the southern and eastern United States, and the New Guinea flatworm, Platydemus manokwari, is perhaps the most dangerous of all flatworms to human health. It is also the cause of ecological destruction of native snail species around the world and is currently listed in the “100 of the World's Worst Invasive Alien Species” (Global Invasive Species Database, Invasive Species Specialist Group (ISSG), of the Species Survival Commission (SSC), of the International Union for Conservation of Nature (IUCN). Current listing). In comparison to other flatworms, it poses an even greater danger to ecosystems and agricultural interests. Since first being discovered in Miami in 2012, New Guinea flatworms, Platydemus manokwari, have, as of 2023, been documented in increasing numbers throughout Florida and at two locations in Alabama. The worms are considered invasive in twenty-two countries and have been an ongoing problem in the State of Hawaii, USA.

New Guinea flatworms disrupt the natural ecology of an ecosystem by being carnivorous predators on a wide variety of vertebrate and invertebrate animal species. Without any natural predators, they are particularly aggressive, attacking and consuming native snails and slugs. Scientists have observed some native snail populations being completely decimated within localized areas invaded by New Guinea flatworms (Iwai, N. and Sugiura, S. (2010) “Predation impacts of the invasive flatworm Platydemus manokwari on eggs and hatchlings of land snails”. Journal of Molluscan Studies, Vol. 76:3 pg 275-278). The animals, e.g., fish, birds, reptiles, and mammals that utilize snails as a primary or even secondary food source are denied essential nutrition. Highly specialized species like the Everglades Snail Kite Rostrhamus sociabilis, having a diet almost totally dependent on the presence of Florida apple snails Pomacea maculate, could become even more locally endangered as their sole food source is removed.

Currently, there is no safe method for killing these worms. If crushed, broken, or chopped into pieces, the worm simply regenerates, and each piece of the worm can regenerate a whole new worm. The worms also pose a medical danger to anyone that knowingly or inadvertently comes into physical contact with them. This is due to the toxic slime the worms secrete. When bare skin meets the worm's slime/mucus coating it produces a reaction like a chemical burn or a severe allergic skin reaction. Medical and scientific sources suggest plastic or latex gloves should always be worn if contact with this worm is anticipated. Unfortunately, the most recommended method to kill the worms is to immerse them in hot water (43° C.) or (109-120° F.) for at least five minutes, or to manually drop salt on the worm and then place it into a solution of bleach or vinegar (Miller, C. (July 2015) Invasive Alert: New Guinea flatworm, University of Florida/Institute of Food and Agricultural Sciences Extension Service Publication). All current governmental, scientific, and medical expert recommendations to kill flatworms are time intensive, impractical, or dangerous to implement on either large- or small-scale applications.

A more serious consequence of human contact with New Guinea flatworms or their slime coating exists in the possibility of contracting a debilitating, often fatal disease known as rat lungworm disease or Angiostrongyliasis. This disease affects the central nervous system in general. Specifically, it attacks the brain and spinal cord. It causes a rare type of meningitis known as eosinophilic meningitis. The disease is manifested when the parasitic nematode (roundworm parasite) Angiostrongylus cantonensis, deposited in the feces of rodents (most typically rats) is incidentally ingested by snails, slugs, and other animals like freshwater shrimp, crayfish, and frogs. These animals become intermediate hosts to the parasite. Because New Guinea flatworms are highly predaceous on snails, slugs, and other organisms that carry the roundworm parasite in their bodies, it can be deposited onto other surfaces like fruits and vegetables via flatworm slime trails. At this point, simply handling or ingesting produce that has not been properly washed can, and has, resulted in contracting fatal Angiostrongyliasis. (Accidental Host—The Story of Rat Lungworm Disease. (2023) The Health Quest Foundation, wen address: ratlungwormfilm.com.)

In most cases (55%), individuals need only to ingest fruit or vegetables contacted by worms to become infected. This is because the rat lungworm larvae were left in a nearly invisible slime trail produced by worms that have crawled over fruit or vegetables subsequently eaten by humans (Walczuk, Maria, K. Beyond the Fear: A Documentary about Rat Lungworm Disease (2016) Documentary). Moreover, due to the relatively new appearance of this disease, it is unknown how many doctors will fail to recognize the eosinophilic meningitis caused by Angiostongylus cantonensis. (Liu et al., “Rat Lungworm Infection Associated with Central Nervous System Disease—Eight U.S. States, January 2011-January 2017” Centers for Disease Control and Prevention (CDC), Morbidity and Mortality Weekly Report (MMWR) Aug. 3, 2018/67 (30); 825-828). The possibility of misdiagnosis and under reporting of this infection is very likely and would be especially likely in the southeastern United States where the previously unknown New Guinea flatworm infestation is currently undergoing a population explosion.

In a native biome, most flatworms are well regulated by natural predation, mortality from physical factors, seasonality, or a lack of hosts or viable prey organisms. It is not until they reach 10 new habitat through intentional or accidental introduction that they become a problem. As such, very little research has been undertaken to stop or prevent the spread of invasive flatworms.

### SUMMARY OF THE INVENTION

Embodiments of the invention provide for a composition, and methods, for selectively controlling and killing invasive flatworms in Phylum Platyhelminthes. The compositions and methods are designed to the control of invasive flatworms, their eggs, their cocoons, and their reproductive fragments in and on plants, plant tissue, plant transportative material, water, soil, turf, roots, root balls, sidewalks, drive ways, play areas, common areas, and surfaces and substrates that are both permeable and impermeable. The composition comprises: 1) degreasing solvent, 2) a surfactant compound, 3) an acid or base, and 4) a monohydric alcohol

Embodiments of the invention provide a method of selectively controlling and killing flatworms in Phylum Platyhelminthes comprising: applying a flatworm composition directly to flatworms, or other forms thereof, in Phylum Platyhelminthes, to a substrate or location/surface on which the flatworms live or travel, to living tissue or plants, or combinations thereof.

Embodiments of the invention provide a method of selectively controlling and killing flatworms in Phylum Platyhelminthes comprising: providing a flatworm composition for selectively controlling and killing flatworms in Phylum Platyhelminthes, comprising, in effective amounts, a degreasing solvent; a surfactant; an acid or a base; a monohydric alcohol; and applying said flatworm composition directly to said flatworms in Phylum Platyhelminthes, or other forms thereof, to a substrate or location/surface on which the flatworms live or travel, to living tissue or plants, or combinations thereof.

Accordingly, it is an objective of the invention to provide a composition, and method, for selectively controlling and killing flatworms in Phylum Platyhelminthes.

It is a further objective of the invention to provide a composition for controlling highly invasive, harmful flatworms without unduly disrupting native or commercially important agricultural biomes.

It is yet another objective of the invention to provide a method for controlling highly invasive, harmful flatworms without unduly disrupting native or commercially important agricultural biomes.

It is a still further objective of the invention to provide a composition that poses low risk to complex environmental ecosystems.

It is a further objective of the invention to provide a composition made with relatively safe, minimally ecologically disruptive, and non-persistent components.

It is yet another objective of the invention to provide a composition for selectively controlling and killing various forms of the flatworms in Phylum Platyhelminthes, including flatworm larvae, flatworm eggs, flatworm reproductive fragments, or flatworm cocoons.

It is a still further objective of the invention to provide a method for selectively controlling and killing various forms of the flatworms in Phylum Platyhelminthes, including flatworm larvae, flatworm eggs, flatworm reproductive fragments, or flatworm cocoons.

It is yet another objective of the invention to provide a composition for selectively controlling and killing various forms of the flatworms in Phylum Platyhelminthes to be applied directly to the flatworms in Phylum Platyhelminthes, or other forms thereof.

It is yet another objective of the invention to provide a method of applying a composition for selectively controlling and killing various forms of the flatworms in Phylum Platyhelminthes directly to the flatworms in Phylum Platyhelminthes, or other forms thereof.

It is a still further objective of the invention to provide a composition for selectively controlling and killing various forms of the flatworms in Phylum Platyhelminthes to be applied to a substrate or location the flatworms live or move thereon.

It is still a further objective of the invention to provide a method of applying a composition for selectively controlling and killing various forms of the flatworms in Phylum Platyhelminthes to a substrate or location the flatworms live or move thereon.

It is a further objective of the invention to provide a composition for selectively controlling and killing various forms of the flatworms in Phylum Platyhelminthes to be applied to living tissue or plants.

It is a further objective of the invention to provide a method of applying a composition for selectively controlling and killing various forms of the flatworms in Phylum Platyhelminthes to living tissue or plants.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1A is a schematic representation of the action of the flatworm composition on flatworm physiology, illustrating the flatworm composition being applied to a flatworm being;

FIG. 1B is a schematic representation of the action of the flatworm composition on flatworm physiology, illustrating several of the flatworm composition components modes of action;

FIG. 1C is a schematic representation of the action of the flatworm composition on flatworm physiology, illustrating the flatworm death as a result of metabolic collapse;

FIG. 2 is a graphic representation of the effect of the formulation on New Guinea flatworms Platydemus manokwari and common earthworms Lumbricus sp.;

FIG. 3 is a graphic representation of the effect of the formulation on New Guinea flatworms Platydemus manokwari and apple snails Pomacea; and

FIG. 4 illustrates a flatworm positioned on the ground near a sprayed area, but not entering the area comprising the flatworm composition spayed thereon.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

Embodiments of the invention provide for a composition, referred to generally as a flatworm composition 10, for selectively controlling and killing invasive flatworms in Phylum Platyhelminthes. Use of New Guinea Flatworm as an illustrate example representing the genus Platyhelminthes was provided as the New Guinea Flatworm is illustrate of the worms' (in the phylum) unique physiology. All members of the Phylum Platyhelminthes are relatively simple, bilaterian, unsegmented, soft-bodied invertebrates. They have no body cavity (coelom), no circulatory system, and no respiratory organs. Consequently, they must be relatively thin and flattened to allow gases like oxygen, and liquids such as water to pass directly through the skin into the worm, and then carbon dioxide and bodily waste products to pass back out through the skin as quickly as possible. Terrestrial flatworms have the unique ability to secrete a polysaccharide mucus that undoubtedly helps to prevent evaporation and subsequent desiccation of the worms. In some species, like the New Guinea flatworm, it also contains toxins that act as skin irritants to humans and deterrents for predators.

Accordingly, highly invasive, harmful flatworms can be controlled without unduly disrupting native or commercially important agricultural biomes. The composition comprises: 1) degreasing solvent that selectively removes the protective mucus coating from the flatworm, 2) a surfactant compound that acts as a mucus coat dissolving/stripping agent in conjunction with a 3) moderate to strong acid or base that induces metabolic collapse and death within the worm, and 4) a monohydric alcohol to accelerate this process. The alcohol likely accelerates metabolic collapse by allowing the acid or base to enter a worm more quickly by drying the dermis. It also decreases the required concentration of the acid or base (strong or weak) that is needed for rapid mortality. The detergent, SLS reduces the surface tension of water allowing the degreaser to disperse more effectively over the worm, quickly removing the mucus sheath. This allows the monohydric alcohol to expose the dermis for almost instantaneous contact with the acid or base. While not catalysts in the traditional sense, the monohydric alcohol and the SLS do accelerate the activity of the other two components to achieve mortality in the shortest time possible. Accordingly, in certain embodiments, the composition 10 may not include the monohydric alcohol and/or the detergent (SLS). As each of the individual components are relatively safe, minimally ecologically disruptive, and non-persistent components, the flatworm composition 10 poses low risk to complex environmental ecosystems.

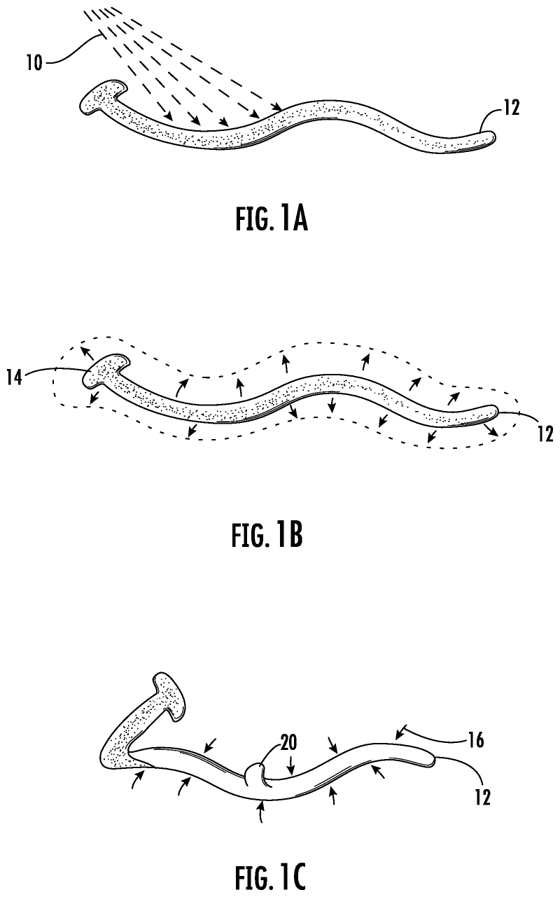

In use, the four components of the flatworm composition 10, in combination, act on flatworm physiology to cause death. Application of the flatworm composition 10, via, for example, bathing the flatworm 12 using a spray form of the flatworm composition 10 starts the action, see FIG. 1A. Once the flatworm composition 10 is applied to the flatworm 12, the degreasing solvent causes the flatworm mucus sheath/coat 14 to dissolve, see FIG. 1B. After contacting the mucus sheath/coat 14 of a flatworm, a polysaccharide-rich mixture gelatinous coating to protect dermal tissue from desiccation is completely dissolved, exposing the dermal tissue. This process is typically observed as a color change. During this process, the typically clear mucus coat becomes opaque and cloudy.

Subsequently, there is a loosening of the mucus cohesion around the flatworm as the mucus sheath/coat 14 dissolves and slides into a thin film against the media on which the flatworm is resting or adhering. The surfactant component of the flatworm composition 10 accelerates the dissolution of the flatworm mucus sheath 14. This occurs once the mucus sheath/coat 14 has been dissolved. The surfactant facilitates maximum contact of the exposed dermal surface with other chemical agents. The acid/base component of the flatworm composition 10 immediately diffuses across the dermal tissue, see arrows 16, FIG. 1C. The exposed dermal tissue is then bathed with the acidic or basic solution contained in the flatworm composition 10. As the exposed dermal tissue encounters the acid or base, it is quickly, typically within milliseconds, diffused through the dermal layers and into the body tissues and organs.

Death of the flatworm is then swift and easily recognizable (protruding pharynx, twisted body). The pharynx 20 (see FIG. 1C) is typically ejected inside out on the ventral side as the flatworm contorts on its dorsal axis into a curved posture allowing the pharynx 20 to point upward, giving visual confirmation of mortality. The addition of a monohydric alcohol to the formulation is desirable for the drying effect and acceleration of the formula activity. The specific combination of chemical components in the flatworm composition 10 provides a high degree of selective effectiveness in the control and removal of invasive flatworm species.

The flatworm composition 10 is beneficial by acting as a pesticide that is environmentally friendly for controlling invasive flatworms found in soil, turf, root balls, plants, water, plant transportative materials (soils, vermiculite, sphagnum moss, or materials used in root balls to ship live plants), and a variety of other surfaces and combinations thereof. The combination of the degreasing agent with the surfactant and moderate to strong acidic or basic solution, with or without the addition of a monohydric alcohol, does not present any notable mortality in segmented worms e.g., earthworms or mollusks, e.g., slugs or snails, or arthropods or insects having an exoskeleton that may also be present in or on the substrate to which the formulation has been applied.

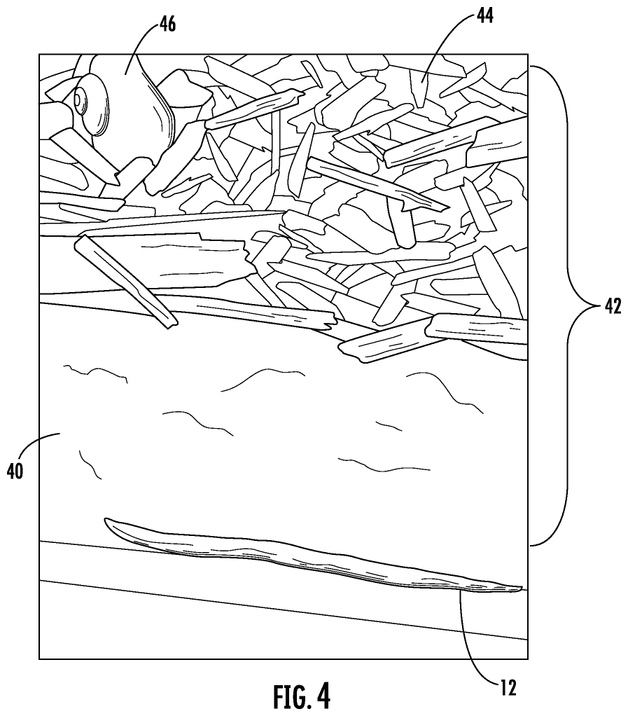

In addition to the controlling (referring to the complete or partial mortality, or resulting residue inhibiting reentry of the worms to an area that has been treated) and killing of the flatworms, the flatworm composition 10 may control and kill flatworm larvae, flatworm eggs, flatworm cocoons, and flatworm reproductive fragments. Referring to FIG. 4, the flatworm 12 is shown positioned on the ground near a sprayed area 42, an area that has been sprayed with the flatworm composition 10. The sprayed area 42 includes mulch 44 and a living snail 46. As depicted by the figure, the flatworm 12 moves or stays away (does not reenter) from the spray zone, i.e. the sprayed area 42.

Accordingly, the flatworm composition 10 may control and kill flatworms, flatworm larvae, flatworm eggs, flatworm cocoons, and flatworm reproductive fragments in and on plants, plant tissue, plant transportative material, water, soil, turf, roots, root balls, sidewalks, drive ways, play areas, common areas, and surfaces and substrates that are both permeable and impermeable. The flatworm composition 10 may control and kill flatworm, flatworm larvae, flatworm eggs, flatworm cocoons, and flatworm reproductive fragments on the surface of a plant. The flatworm composition 10 may control and kill flatworm, flatworm larvae, flatworm eggs, flatworm cocoons, and flatworm reproductive fragments in an aqueous environment.

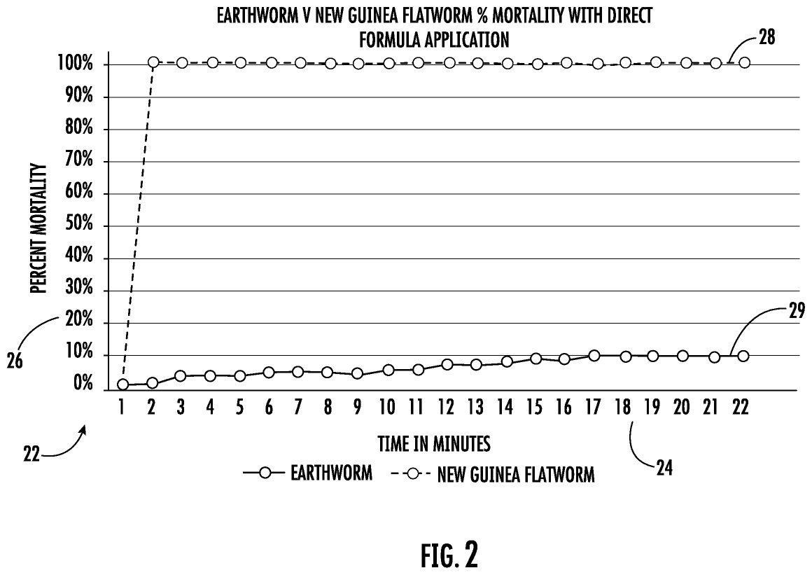

Referring to FIG. 2, a graphic representation 22 of the effect of the flatworm composition 10 on New Guinea flatworms Platydemus manokwari and common earthworms Lumbricus sp. required to achieve 100% mortality in flatworms and the time (in seconds) to accomplish that level of mortality is illustrated. The comparative mortality of the common earthworm exposed to the same level of the formulation is also expressed as % mortality over the same amount of time. The graphic representation 22 includes the time in minutes on the X-axis, 24, and the percent mortality on the Y-axis, 26. The comparative mortality of the common earthworm exposed to the same level of the formulation is also expressed as % mortality over the same amount of time. As shown, the New Guinea flatworms 28 reached 100% morality within 1 minute of contact with the flatworm composition 10. Contact of the flatworm composition 10 with the common earthworms 29 was near 10% at 14 minutes.

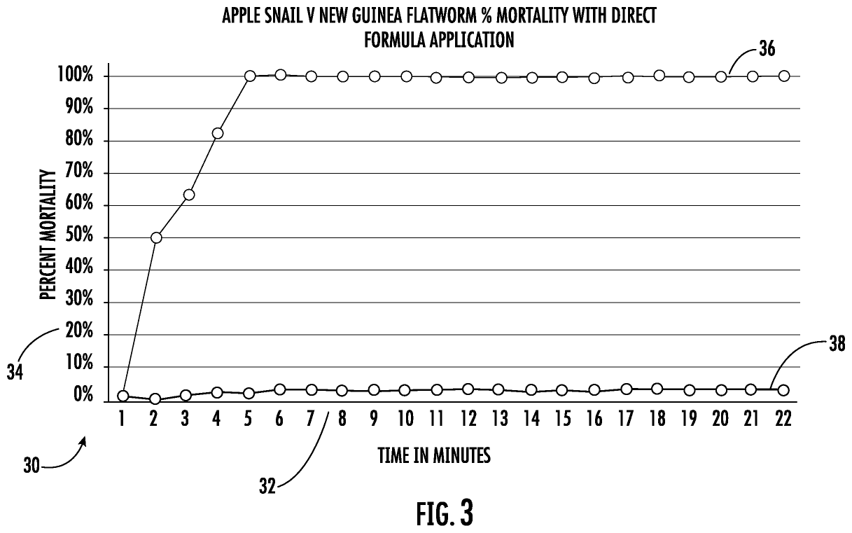

FIG. 3 is a graphic representation 30 of the effect of the formulation on New Guinea flatworms Platydemus manokwari and apple snails Pomacea required to achieve 100% mortality in flatworms and the time (in seconds) to accomplish that level of mortality. The graphic representation 30 includes the time in minutes on the X-axis, 32, and the percent mortality on the Y-axis, 34. The comparative mortality of apple snails exposed to the same level of formulation is also expressed as % mortality over the same amount of time. As shown, the New Guinea flatworms 36 reached 100% morality within 4 minutes of contact with the flatworm composition 10. Contact of the flatworm composition 10 with the Apple Snail 38 was less than 5% at 22 minutes.

As used herein, the term “degreasing solvent” is defined as an agent that solubilizes the organic hydrogel mucus that is secreted by the flatworms. The hydrogel in most terrestrial flatworms contains at least forty polypeptides that comprise the protein and typically larger carbohydrate component of the mucus sheath/coat 14. It is the degreasing solvent that initiates the dissolution process on the mucus sheath/coat 14. Ideally, it is a naturally derived cyclic monoterpene capable of rapid, safe dissolution in the natural environment.

As used herein, “surfactant” consists substantially of a water-soluble surface-active composition with a lipophilic branch capable of emulsifying or dissolving lipids or oils in or on living tissue and acting as a detergent to mucus or organic secretions emitted by flatworms. The surfactant effectively accelerates and washes the remaining mucus from the flatworm epidermis, exposing the flatworm to maximum direct contact with the moderate to strong acidic or basic solution being applied.

As used herein, “moderate to strong acidic or basic solution” is preferably an organic acid or base that has a natural, non-persistent effect in the environment. Most of the hydroxide dissociative bases e.g., ammonium hydroxide and natural organic acids e.g., citric, or acetic acid are especially well suited to the purpose of causing immediate metabolic shock and death of the worm by diffusion across the exposed dermal layer. Virtually all internal organs are affected and typically the pharynx is ejected, distended, and protruding from the ventral surface as metabolic functions collapse and the worm dies. A such, the use of “moderate to strong acidic or basic” refers to using acids or bases that are strong enough to produce the desired results. Whether using a weak base in a higher concentration, or a strong base used in lesser concentration, the concentration and/or type can be altered to meet environmental guidelines, health and safety requirements, and of course the effectiveness of the product. Consequently, the terms “strong” or “weak” is simply an ionization identifier for the acid or base, and is not an indication of concentration required to make the formulation effective.

As used herein, the term “monohydric alcohol” is a desiccant, although there is some evidence that it additionally acts as a denaturant. Desiccation of the exposed tissue once the mucus sheath/coat has been removed seems to enhance penetration of the strong to moderate acidic or basic solution into the worm. The enhanced penetration is largely due to accelerated absorption of the acid or base through the exposed tissue. This accelerated penetration and diffusion of the acid or base decreases the time to mortality and often, dependent upon concentrations and formulation component ratios, provides instantaneous death of the flatworm. The monohydric alcohol can allow for the other components to be used in lesser concentrations to achieve the same result in less time under the appropriate environmental conditions. The monohydric alcohol may also provide a denaturing effect on the proteins found in the mucus hydrogel and associated proteins within the worm, contributing to mortality.

Degreasing solvent: The flatworm composition 10 may include the degreasing solvent at concentration of at least 0.25% of the total weight of the flatworm composition 10, and preferably not more than 5% by weight. In a preferred embodiment, the degreasing agent is at a concentration of 2%. In certain embodiments of the flatworm composition 10, the degreasing solvent used in is a naturally occurring degreaser such as, but not limited to, terpenes, d-Limonene, p-Cymene, or a-Pinene. Natural degreasers provide a viable alternative to synthetically derived VOC solvents and limit environmental and potential health impacts. Partial or multiple combinations of the degreasing solvents can lower the limited environmental impacts with no loss of effectiveness or efficacy to the flatworm composition 10.

In certain embodiments of the flatworm composition 10, other chemically synthesized degreasers may be used as well, such as 2-Butoxyethanol, Ethoxytriglycol, Diethylene Glycol Monoethyl Ether, propylene glycol, or glycerol. Other Glycol ethers that serve as degreasing agents, 2-methoxyethanol, 2-ethoxyethanol, 2-propoxyethanol, 2-isopropoxyethanol, 2-phenoxyethanol, 2-benzyloxyethanol, (2-(2-methoxyethoxy) ethanol, (2-(2-butoxyethoxy) ethanol, Dipropyleneglycol methyl ether, Ethylene glycol diethyl ether, and Ethylene glycol dibutyl ether can be used as the degreasing component of the degreasing/surfactant constituent fraction of the invention.

Surfactants: The flatworm composition 10 may include surfactants at concentrations of at least 0.01% of the total weight of the flatworm composition 10, and preferably not more than 5% by weight. In a preferred embodiment, the surfactant is used at a concentration of 1%, or at least 1% of the total weight. In a preferred embodiment, the surfactant is used at a concentration of 2%, or at least 2% of the total weight.

In certain embodiments, the flatworm composition 10 may comprise an anionic surfactant, such as sodium lauryl ether sulfate (SLES), or may contain an esterified sulfuric acid e.g., alkylethanolamide ether sulfate, alkylphenol ether sulfate, alkylphenol sulfate, alklethanolamide sulfate, alkane sulfonate, alkyl ether sulfonate, alkylbenzene sulfonate, alkyl sulfate, alkyl ether sulfate, olefin sulfonate or an alpha sulfo fatty acid or its esters having at least one alkyl or alkenyl group with 8 to 22 aliphatic carbon atoms. These alkyl or alkenyl groups have primarily straight chain groups, but may have secondary or branched chain groups. Polyoxyalkylene groups such as glyceryl, polyocypropylene, polyoxyethylene and other mixed polyoxyethylene-oxypropylene, glyceryl-oxypropylene, and glyceryl-oxyethylene and glyceryl-oxyethylene-oxypropylene groups normally contain 1-22 oxyalkylene groups. Sulfated or sulfonated surfactants like sodium lauryl sulphate, sodium dodecyl dimethyl benzene sulphonate, potassium hexadecyl benzene sulfonate, sodium dodecyl benzene sulfonate, and ammonium lauryl monoethoxy sulfate are viable constituents.

In certain embodiments, the flatworm composition 10 may comprise naturally occurring anionic surfactants such as linoleats, oleates, palmitates, resinates, sterates, alkyl ether carboxylates, rosin soaps and other fatty alky sulfonsuccinates, fatty alkyl ether sulfosuccinamates, fatty alkyl ether sulfosuccinates, fatty alkyl sulfossuccinates, acyl taurides, and acyl sarcosinates with at least one aliphatic hydrocarbon chain having 8 to 22, and ideally 10 to 20, with a majority of 12 to 18 carbon atoms and an ionisable acidic group, e.g. carboxy, sulfate, sulfoacid, phosphono or acidic phosphate group with, in the case of ethers, one or more glycerol, ethyleneoxy and propyleneoxy groups could all be used in the flatworm composition 10. Ideally, the surfactant would be a sodium salt. Other salts, e.g. ammonium, monoethanolamine, magnesium, potassium, calcium, lithium, triethanolamine, diethanolamine and alky amine, with up to seven aliphatic carbon atoms could be used.

In certain embodiments, the flatworm composition 10 may comprise nonionic surfactants may also be used. These surfactants would include ethoxylated alkylolamides, ethoxylated glyceryl esters, ethoxylated alkylphenols, ethoxylated carboxylic acids, ethoxylated alcohols, ethoxylated phosphate esters, ethoxylated sorbitan esters and butoxylated, propoxylated, and mixtures of all of the aforementioned nonionic surfactants having 8 to 22 carbons with alkyl or alkenyl groups.

In certain embodiments, the flatworm composition 10 may comprise a variety of cationic surfactants that include quaternary amines that have at least one alkyl or alkenyl group and/or one benzyl group with the rest of the four (reference to number of alkyl/alkenyl or benzyl groups attached to the quaternary amines.) substituents being short chain alkyl groups.

These cationic surfactants would include quaternized imidazolines and imidazoline that have one long chain alkenyl or alkyl group. That would also include amido amines and quaternized amido amines having at least one long chain alkyl or alkenyl group. Quaternized surfactants are typically anionic salts that increase water solubility, e.g., chloride, sulphate, nitrate, tartrate, acetate, lactate, or formate.

In certain embodiments, the flatworm composition 10 may comprise amphoteric surfactants like sulfobetaines, betaines, and phosphobetaines that are formed by reaction with a tertiary nitrogen compound with a long chain alkyl or alkenyl group with compounds like propane sulfone or chloroacetic acid, which may also be used in the flatworm composition 10.

While the above listing of surfactants is contemplated for use as part of the flatworm composition 10, any surfactant capable of dissolution of the mucus coating of a Platyhelminth could be used.

Acid/Base Component: In certain embodiments, the flatworm composition 10 comprises a moderate to strong acid or base. In certain embodiments, the flatworm composition 10 comprises at least 0.3% (total weight of the flatworm composition 10) of a moderate to strong base. In certain embodiments, the flatworm composition 10 comprises at least 2.0% (total weight of the flatworm composition 10) of a moderate to strong base. In certain embodiments, the flatworm composition 10 comprises at least 3.0% (total weight of the flatworm composition 10) of a moderate to strong base. In certain embodiments, the flatworm composition 10 comprises at least 4.0% (total weight of the flatworm composition 10) of a moderate to strong base.

In certain embodiments, the base of the flatworm composition 10 may include ammonium in the form of ammonium hydroxide, lithium hydroxide, sodium hydroxide, potassium hydroxide, or calcium hydroxide.

In certain embodiments, the flatworm composition 10 comprises at least 0.3% (total weight of the flatworm composition 10) of a moderate to strong acid. In certain embodiments, the flatworm composition 10 comprises at least 2.0% (total weight of the flatworm composition 10) of a moderate to strong acid. In certain embodiments, the flatworm composition 10 comprises at least 3.0% (total weight of the flatworm composition 10) of a moderate to strong acid. In certain embodiments, the flatworm composition 10 comprises at least 4.0% (total weight of the flatworm composition 10) of a moderate to strong acid.

In certain embodiments, the acid of the flatworm composition 10 may include, methanoic acid, ethanoic acid, ethanedioic acid, oxoethanoic acid, 2-hydroxyethanoic acid, propanoic acid, prop-2-enoic acid, 2-propynoic acid, propanedioic acid, 2-hydroxypropanedioic acid, oxopropanedioic acid, 2, 2-dihydroxypropanedioic acid, 2-oxopropanoic acid, 2-hydroxypropanoic acid, 3-hydroxypropanoic acid, 2,3-dihydroxypropanoic acid, 2-oxiranecarboxylic acid, butanoic acid, 2-methylpropanoic acid, 2-oxobutanoic acid, 3-oxobutanoic acid, 4-oxobutanoic acid, (E)-butenedioic acid, (Z)-butenedioic acid, But-2-ynedioic acid, oxobutanedioic acid, hydroxybutanedioic acid, 2,3-dihydroxybutanedioic acid, (E)-but-2-enoic acid, pentanoic acid, 3-Methylbutanoic acid, pentanedioic acid, 2-oxopentanedioic acid, hexanoic acid, hexanedioic acid, 2-hydroxpropane-1, 2, 3-tricarboxylic acid, prop-1-ene-1, 2, 3-tricarboxylic acid, 1-hydroxypropane-1, 2, 3-tricarboxylic acid, (2E, 4E)-hexa-2, 4-dienoic acid, heptanoic acid, heptanedioic acid, cyclohexanecarboxylic acid, benzenecarboxylic acid, 2-hydroxybenzoic acid, octanoic acid, benzene-1,2-dicarboxylic acid, nonanoic acid, benzene-1, 3, 5-tricarboxylic acid, or (E)-3-phenylprop-2-enoic acid.

Alcohol Component: In certain embodiments, the flatworm composition 10 comprises an alcohol component. The alcohol is at a concentration that allows for accelerating the process. In certain embodiments, the flatworm composition 10 comprises at least 0.5% (total weight of the flatworm a monohydric alcohol. In certain composition 10) of embodiments, the flatworm composition 10 comprises at least 2.0% (total weight of the flatworm composition 10) of a monohydric alcohol. In certain embodiments, the flatworm composition 10 comprises at least 3.0% (total weight of the flatworm composition 10) of a monohydric alcohol. In certain embodiments, the flatworm composition 10 comprises at least 4.0% (total weight of the flatworm composition 10) of a monohydric alcohol. In certain embodiments, the flatworm composition 10 comprises at least 5.0% (total weight of the flatworm composition 10) of a monohydric alcohol.

In certain embodiments, the alcohol of the flatworm composition 10 may include methanol, ethanol, or propan-2-ol. The alcohols at the highest levels provide limited improvement in the formulation. Polyhydric alcohols, like Propylene glycol, may act more like degreasing agents and provide less of the desired desiccant properties.

The flatworm composition 10 acts as a pesticide that is highly effective and non-persistent in the environment in controlling and eradicating invasive, destructive flatworm species Phylum Platyhelminthes. The flatworm composition 10, when in direct contact with, or in close proximity to flatworms produces rapid and complete mortality. The flatworm composition 10 may be applied using a method which uses a direct application of spray or saturation of the flatworms on plants, surfaces, turf, root balls, soil, or other plant transportive materials. Additionally, there is an inhibitory effect of flatworm composition 10 after application that deters and repels flatworms from reentering the treated area. The selective nature of the flatworm composition 10 limits mortality of organisms in other vertebrate and invertebrate animal phyla, limiting collateral mortality of potentially beneficial organisms in those same materials.

The method of selectively controlling and killing flatworms in Phylum Platyhelminthes may comprise providing and/or applying any embodiment of the flatworm composition 10. The flatworm composition 10 may be applied directly to the flatworms or indirectly to the soil, root ball, plant, water, soil, substrate, or medium in or on which the adult worms, larvae, eggs, reproductive fragments, or egg cocoons are contained. Application of the flatworm composition 10 may be accomplished by direct spray or stream using manual or automated methods, such as but not limited to compressed sprayers, vapor applicators, direct drip from applicators, root ball or whole plant immersion in a bath prior to shipping or immediately after importation, or any other mechanisms to apply the liquid to an affected area known to one of skill in the art. Application of the flatworm composition 10 may be accomplished by immersion using manual or automated methods. Application of the flatworm composition 10 to turf may be accomplished by injection, aerial spraying, stream application, or other methods of saturation. Application of the flatworm composition 10 to root balls or transportative plant materials may be by immersion, spray or stream application using manual or automated methods with an effective amount of the formula. Application of the flatworm composition 10 to an aqueous environment(s) may be by mist or direct introduction into the aquatic body of water containing the flatworms by manual or automated methods.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A composition for selectively controlling and killing flatworms in Phylum Platyhelminthes comprising:
a degreasing solvent;
a surfactant;
an acid or a base; and
a monohydric alcohol.

2. The composition for selectively controlling and killing flatworms in Phylum Platyhelminthes according to claim 1, wherein said degreasing solvent concentration is between 0.1% and 5% by weight.

3. The composition for selectively controlling and killing flatworms in Phylum Platyhelminthes according to claim 1, wherein said surfactant concentration is between 0.001% and 5% by weight.

4. The composition for selectively controlling and killing flatworms in Phylum Platyhelminthes according to claim 1, wherein said acid or a base concentration is between 0.1% and 5% by weight.

5. The composition for selectively controlling and killing flatworms in Phylum Platyhelminthes according to claim 1, wherein said monohydric alcohol concentration is between 0.25% and 7% by weight.

6. The composition for selectively controlling and killing flatworms in Phylum Platyhelminthes according to claim 1, wherein
said degreasing solvent is at a concentration of between 0.1% and 5% by weight;
said surfactant is at a concentration of between 0.001% and 5% by weight;
said acid is at a concentration of between 0.1% and 5% by weight; and
said monohydric alcohol is at a concentration of between 0.25% and 7% by weight.

7. The composition for selectively controlling and killing flatworms in Phylum Platyhelminthes according to claim 1, wherein
said degreasing solvent is at a concentration of between 0.1% and 5% by weight;
said surfactant is at a concentration of between 0.001% and 5% by weight;
said base is at a concentration of between 0.1% and 5% by weight; and
said monohydric alcohol is at a concentration of between 0.25% and 7% by weight.

8. The composition for selectively controlling and killing flatworms in Phylum Platyhelminthes according to claim 1, wherein said surfactant is a water-soluble, surface-active composition.

9. The composition for selectively controlling and killing flatworms in Phylum Platyhelminthes according to claim 1, wherein said surfactant is an esterified sulphuric acid.

10. The composition for selectively controlling and killing flatworms in Phylum Platyhelminthes according to claim 9, wherein said esterified sulfuric acid is sulfated or sulfonated surfactant like sodium lauryl sulfate or sodium dodecyl dimethyl benzene sulfonate in water.

11. The composition for selectively controlling and killing flatworms in Phylum Platyhelminthes according to claim 1, wherein said degreasing solvent is glycol ether or terpene.

12. The composition for selectively controlling and killing flatworms in Phylum Platyhelminthes according to claim 11, wherein said terpene is d-Limonene, p-Cymene or a-Pinene.

13. The composition for selectively controlling and killing flatworms in Phylum Platyhelminthes according to claim 1, wherein said base is ammonium hydroxide, lithium hydroxide, sodium hydroxide, or calcium hydroxide.

14. The composition for selectively controlling and killing flatworms in Phylum Platyhelminthes according to claim 1, wherein said acid is hydrochloric acid, ethanoic or monocarboxylic acid, citric acid, 2-hydroxypropane-1, 2, 3-tricarboxylic acid.

15. The composition for selectively controlling and killing flatworms in Phylum Platyhelminthes according to claim 1, wherein said monohydric alcohol is propan-2-ol, methanol, ethanol, or a polyhydric alcohol.

16. The composition for selectively controlling and killing flatworms in Phylum Platyhelminthes according to claim 1, wherein said flatworm is the New Guinea flatworm.

17. A method of selectively controlling and killing flatworms in Phylum Platyhelminthes comprising:
providing a flatworm composition for selectively controlling and killing flatworms in Phylum Platyhelminthes, comprising, in effective amounts,
a degreasing solvent;
a surfactant;
an acid or a base; and
a monohydric alcohol;
applying said flatworm composition directly to said flatworms in Phylum Platyhelminthes, or other forms thereof, to a substrate or location said flatworms live or move thereon, to living tissue or plants, or combinations thereof.

18. The method of selectively controlling and killing flatworms in Phylum Platyhelminthes according to claim 17, wherein
said degreasing solvent is at a concentration of between 0.1% and 5% by weight;
said surfactant is at a concentration of between 0.001% and 5% by weight;
said base is at a concentration of between 0.1% and 5% by weight; and
said monohydric alcohols is at a concentration of between 0.25% and 7% by weight.

19. The method of selectively controlling and killing flatworms in Phylum Platyhelminthes according to claim 17, wherein said flatworm composition is applied to said substrate or location where said flatworms live or move thereon or directly to said flatworms via spray, stream, immersion, injection, or mist.

20. The method of selectively controlling and killing flatworms in Phylum Platyhelminthes according to claim 17, wherein said substrate or location where said flatworms live or move thereon is an aqueous environment.

21. The method of selectively controlling and killing flatworms in Phylum Platyhelminthes according to claim 20, wherein said aqueous environment is a body of water.

22. The method of selectively controlling and killing flatworms in Phylum Platyhelminthes according to claim 17, wherein said substrate or location where said flatworms live or move thereon is a sidewalk or drive way, play areas, common areas, and surfaces and substrates that are both permeable and impermeable.

23. The method of selectively controlling and killing flatworms in Phylum Platyhelminthes according to claim 17, wherein said substrate or location where said flatworms live or move thereon are permeable or impermeable surfaces.

24. The method of selectively controlling and killing flatworms in Phylum Platyhelminthes according to claim 17, wherein said substrate or location where said flatworms live or move thereon located is soil or turf.

25. The method of selectively controlling and killing flatworms in Phylum Platyhelminthes according to claim 17, wherein said living tissue or plants includes plants, plant tissue, plant transportative material, roots, or root balls.

26. The method of selectively controlling and killing flatworms in Phylum Platyhelminthes according to claim 17, wherein other forms of said flatworms in Phylum Platyhelminthes include flatworm larvae, flatworm eggs, flatworm reproductive fragments, or flatworm cocoons.

27. A method of selectively controlling and killing flatworms in Phylum Platyhelminthes comprising:
applying a flatworm composition directly to flatworms, or other forms thereof, in Phylum Platyhelminthes, to a substrate or location where said flatworms live or move thereon, to living tissue or plants, or combinations thereof, said flatworm composition comprising,
a degreasing solvent at a concentration of between 0.1% and 5% by weight;
a surfactant at a concentration of between 0.001% and 5% by weight;
an acid or a base at a concentration of between 0.1% and 5% by weight; and
a monohydric alcohol at a concentration of between 0.25% and 7% by weight.
